(19) United States
(12) Patent Application Publication
(10) Pub. No.: US 2013/0019009 A1
(43) Pub. Date: Jan. 17, 2013

(54) METHOD AND SYSTEM FOR SUBSCRIBER JOURNEY ANALYTICS

(71) Applicants: Marc Tremblay, Montreal (CA); Eric Melin, Montreal (CA)

(72) Inventors: Marc Tremblay, Montreal (CA); Eric Melin, Montreal (CA)

(73) Assignee: NEURALITIC SYSTEMS, Montreal, QC (CA)

(21) Appl. No.: 13/519,602

(22) PCT Filed: Dec. 22, 2010
(86) PCT No.: PCT/CA10/02058

§ 371 Date: Sep. 30, 2012

Related U.S. Application Data
(60) Provisional application No. 61/290,949, filed on Dec. 30, 2009.

(51) Int. Cl. G06F 15/173

(52) U.S. Cl. 709/224

(57) ABSTRACT

The present method and system relate to analyzing journeys of at least one subscriber consuming a plurality of Internet services, using at least one device over multiple access technologies. The method and system store in a database, for each subscriber, a series of unique identifiers, each unique identifier corresponding to a specific device of the subscriber. The method and system collect, by means of multiple monitoring probes, real time data from IP traffic; and extract information from the collected real time data, the information comprising one of the unique identifiers. The information is transmitted to an analytic system, where it is aggregated per subscriber, using the unique identifiers to federate the plurality of devices for the same subscriber over the multiple access technologies. For each subscriber, a journey is generated, by processing the aggregated information with the analytic system.

### SUMMARY

A method and system are disclosed to analyze journeys of at least one subscriber consuming a plurality of Internet services, using at least one device over multiple access technologies. The method and system store in a database, for each subscriber, a series of unique identifiers, each unique identifier corresponding to a specific device of the subscriber. The method and system collect, by means of multiple monitoring probes, real time data from IP traffic; and extract information from the collected real time data, the information comprising one of the unique identifiers. The information is transmitted to an analytic system, where it is aggregated per subscriber, using the unique identifiers to federate the plurality of devices for the same subscriber over the multiple access technologies. For each subscriber, a journey is generated, by processing the aggregated information with the analytic system. A subscriber's journey consists of a list of Internet services consumed by the subscriber, with descriptive parameters. The descriptive parameters may consist of at least one of the following: timestamps to indicate beginning and end of service consumption, type of device used, access technology used, type of Internet service, additional specific parameters related to each specific Internet service.

Additionally, a method and system are disclosed, wherein the subscribers' journeys stored in the database are further analyzed by the analytic system from a Business Intelligence perspective. The analysis from a Business Intelligence perspective includes: determining trends and behaviours among subscribers consuming Internet services over a multitude of devices and access technologies, and identifying clusters of subscribers with similar consumption patterns of Internet services over a multitude of devices and access technologies.

Also, a method and system are disclosed, wherein the multiple monitoring probes are deployed at different locations, to cover the plurality of devices and access technologies available to the subscribers. The monitoring probes include: network probes deployed in a mobile network, network probes deployed in a fixed broadband network, network probes deployed in a fixed/mobile convergence network, embedded probes deployed in mobile devices, embedded probes deployed in Residential Gateways, embedded probes deployed in Set Top Boxes, embedded probes deployed in televisions.

And, a method and system are disclosed, wherein the types of Internet services include: web browsing, messaging, IPTV (Internet Protocol Television) and VOD (Video On Demand), video and audio streaming, on-line gaming, social networking, e-commerce, VoIP (Voice over IP).

### BRIEF DESCRIPTION OF THE DRAWINGS

In the appended drawings:

FIG. 1 illustrates a multiple devices, multiple access networks, and multiple Internet services, environment; according to a non-restrictive illustrative embodiment;

FIG. 2 illustrates a storage of a series of unique identifiers corresponding to specific devices used by a subscriber to access Internet services; according to a non-restrictive illustrative embodiment;

FIG. 3 illustrates a subscriber's journey, according to a non-restrictive illustrative embodiment;

FIG. 4 illustrates a system for subscriber's journey analytics, according to a non-restrictive illustrative embodiment;

FIG. 5 illustrates a system architecture of an analytic system performing subscribers' journey analytics, according to a nonrestrictive illustrative embodiment;

FIG. 6 illustrates a method for subscriber's journey analytics, according to a non-restrictive illustrative embodiment.

### DETAILED DESCRIPTION

Nowadays, end users have the capability to consume specific

Internet services from anywhere and at anytime, and the tendency is to generalize this capability for any type of Internet service. This trend is supported by the availability of such Internet services over various access technologies, such as fixed broadband networks (e.g. DSL (Digital Subscriber Line), cable or optical fiber) and mobile networks (e.g. cellular or WIMAX (Worldwide Interoperability for Microwave Access)). Additionally, various end users' devices (e.g. computer, mobile phone, TV set, gaming platform) support the consumption of Internet services, with an end user experience dependant on the specific technical capabilities and limitations of each device.

A typical example is the availability of web services, originally on computers only; now on mobile phones also, and by extension on any type of device with Internet connectivity. Web services are also becoming available on televisions receiving IPTV (IP based television) services, as a component of interactive services aimed at complementing the traditional television experience.

Another example is the ubiquitous availability of IPTV on standard television appliances, as well as on computers and on any type of multimedia capable devices (including mobile phones).

Various stakeholders are interested in gathering and analyzing the habits and behaviours of subscribers in terms of Internet services consumption. The analysis mentioned here is from a Business Intelligence and marketing perspective. For instance, a converged network Operator, with a fixed broadband network and a mobile network (e.g. cellular or WIMAX), is particularly interested in understanding the dynamics and specific patterns of converged Internet services consumption over the various networks it operates, through a variety of IP enabled multimedia devices.

However, for the present time, means to perform the aforementioned analysis are limited to: either a specific access network technology, or to a limited range of Internet services, or to a specific type of IP enabled multimedia device. Thus, the impact of the availability of converged Internet services cannot be evaluated.

Therefore, there is a need for overcoming the above discussed limitations, related to the analysis of multiple Internet services consumption, via multiple devices, over multiple access technologies. An object of the present method and system are therefore to provide a method and system for subscriber journey analytics.

In a general embodiment, the present method is adapted for analyzing journeys of at least one subscriber consuming a plurality of Internet services using at least one device over multiple access technologies. For doing so, the method stores for each subscriber a series of unique identifiers, each unique identifier corresponding to a specific device of the subscriber. The method collects by means of multiple monitoring probes real time data from IP traffic. The method extracts information from the real time data, the information comprising one of the unique identifiers. The method transmits the information to an analytic system. The method aggregates the information per subscriber, using the unique identifiers to federate the plurality of devices for the same subscriber over the multiple access technologies. The method generates for each subscriber a journey, by processing the aggregated information with the analytic system. A subscriber's journey consists of a list of Internet services consumed by the subscriber, with descriptive parameters.

In another general embodiment, the present system is adapted for analyzing journeys of at least one subscriber consuming a plurality of Internet services using at least one device over multiple access technologies. For doing so, the system comprises a database for storing for each subscriber a series of unique identifiers, each unique identifier corresponding to a specific device of the subscriber. The system comprises multiple monitoring probes for collecting real time data from IP traffic, and for extracting information from the real time data, the information comprising one of the unique identifiers. The system comprises an analytic system for processing the information transmitted by the multiple monitoring probes. The processing includes: aggregating the information per subscriber, using the unique identifiers to federate the plurality of devices for the same subscriber over the multiple access technologies. The processing further includes: generating for each subscriber a journey by processing the aggregated information. A subscriber's journey consists of a list of Internet services consumed by the subscriber, with descriptive parameters.

In an additional embodiment of the present method and system, the descriptive parameters may consist of at least one of the following: timestamps to indicate beginning and end of service consumption, type of device used, access technology used, type of Internet service, additional specific parameters related to each specific Internet service.

In another additional embodiment of the present method and system, the subscribers' journeys stored in the database are further analyzed by the analytic system from a Business Intelligence perspective. The analysis from a Business Intelligence perspective includes: determining trends and behaviours among subscribers consuming Internet services over a multitude of devices and access technologies, and identifying clusters of subscribers with similar consumption patterns of Internet services over a multitude of devices and access technologies.

In another additional embodiment of the present method and system, the multiple monitoring probes are deployed at different locations, to cover the plurality of devices and access technologies available to the subscribers. The monitoring probes include: network probes deployed in a mobile network, network probes deployed in a fixed broadband network, network probes deployed in a fixed/mobile convergence network, embedded probes deployed in mobile devices, embedded probes deployed in Residential Gateways, embedded probes deployed in Set Top Boxes, embedded probes deployed in televisions.

And in still another additional embodiment of the present method and system, the types of Internet services include: web browsing, messaging, IPTV (Internet Protocol Television) and VOD (Video On Demand), video and audio streaming, on-line gaming, social networking, e-commerce, VoIP (Voice over IP).

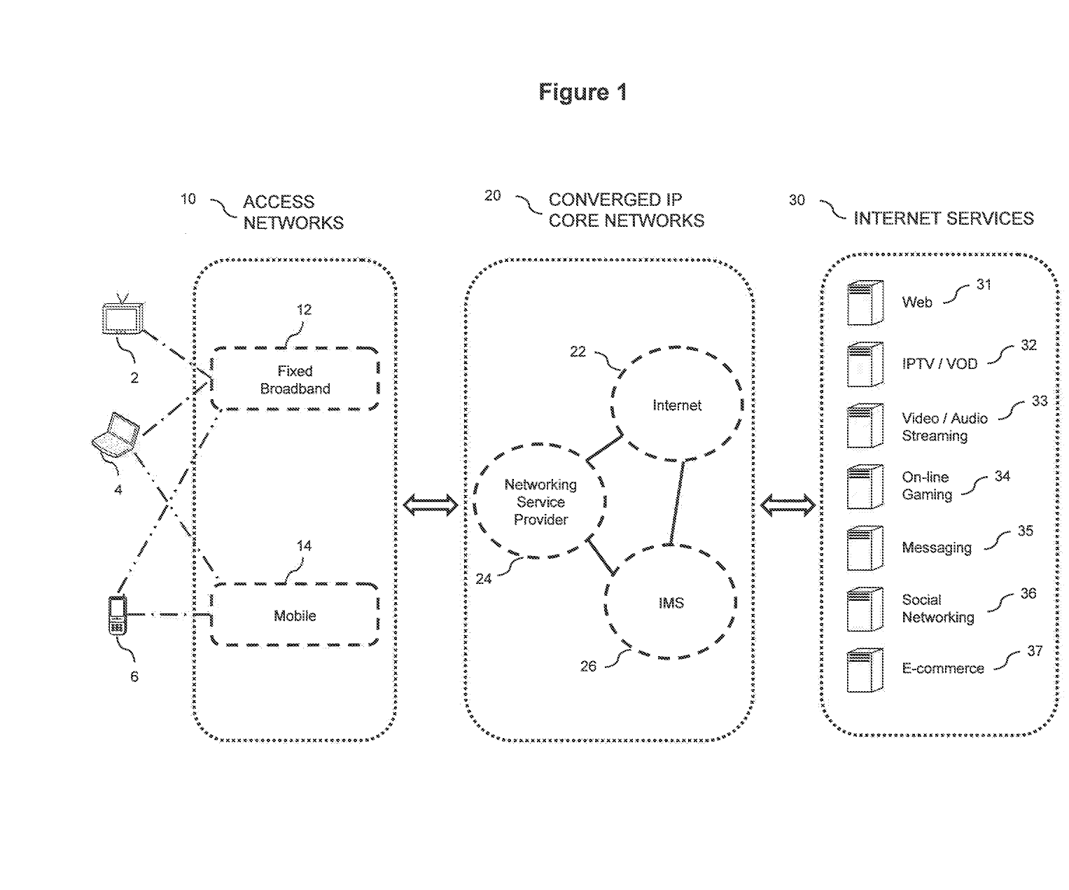

Referring now to FIG. 1, a multiple devices, multiple access networks, and multiple Internet services environment, will be described.

The term “Internet services” shall be interpreted in a broad sense, and encompasses any service delivered over the Internet Protocol (IP). In the present method and system, the Internet services are grouped by types for clarity purposes only. A type of Internet service is represented by all the applications and Internet protocols offering the same type of service to the subscriber, for instance: web browsing, messaging, video and audio streaming, Voice over IP, etc.

Two different access networks 10 are represented in FIG. 1: a fixed broadband access network 12, and a mobile access network 14. Several technologies are used for fixed broadband access network: cable, Digital Subscriber Line (DSL), optical fiber, etc. Several technologies are also used for mobile access network: cellular, WIMAX (Worldwide Interoperability for Microwave Access). WLAN (Wireless Local Area Network) hotspots are not specifically represented in FIG. 1, but are also encompassed by the present access networks 10. Generally speaking, two main categories of access network technologies offering access to Internet services are considered. Mobile technologies (e.g. cellular or WIMAX), offering Internet access from anywhere, in a context of user mobility. And fixed technologies (fixed broadband, WLAN hotspots), offering Internet access at a fixed location (home, hotspot).

Three different devices are represented in FIG. 1: a television 2, a computer 4, and a mobile phone 6, but the present system and method are not limited to these three devices, which are used for exemplary purposes only. Nowadays, a television is capable of providing IP based television services like IPTV (Internet Protocol Television), VOD (Video On Demand), and television related interactive Internet services. Usually, an intermediate equipment not represented in FIG. 1, the STB (Set Top Box), provides the conversion between pure IP based television services, and traditional television technologies supported by the television set itself. Some television sets now have the capability to connect directly to the Internet (via the fixed broadband network 12), to directly support IP based television services, and additional interactive Internet services. In any case, televisions are used in a fixed environment, usually at the subscriber's household premises.

The computer 4 represented in FIG. 1 encompasses a wide range of equipments, with varying form factors and capabilities. Traditional computers, like a PC (Personal Computer), are dedicated to a single environment like the home, and access Internet services via a fixed broadband connection 12. Alternatively, laptops are nomadic devices with the capability to access Internet services via different access technologies. While at home, a fixed broadband connection 12 is used. A WLAN hotspot connection (not represented in FIG. 1) can be used at various locations, where such a WLAN hotspot is available. Additionally, more and more laptops have access to the mobile network 14, currently via a dongle, and in a near future as a native functionality of the laptop. And there is a tendency consisting in the miniaturization of certain types of nomadic computers (such as netbooks, Mobile Internet Devices like tablets, etc), and their capability to access a mobile network. Also, there is a tendency in increasing the computing power and multimedia capabilities of smart phones. Thus, the boundaries between a nomadic device like a laptop and a smart phone are less and less clear.

The mobile phone 6 represented in FIG. 1 has access to Internet services via the IP based mobile data connectivity 14 offered by mobile Operators. As already mentioned, the sophistication of the most advanced types of mobile phones (usually referred to as smart phones) makes them capable of accessing the same type of Internet services that were previously reserved to a PC via a fixed broadband connection 12. Additionally, more and more mobile phones have WLAN connectivity, allowing them to access Internet services from a WLAN hotspot or from the fixed broadband network 12 at home (via WLAN connectivity to the broadband router).

As mentioned above, the general trend is a convergence in device capabilities, in terms of available access technologies, multimedia capabilities, processing power, as well as in terms of Internet services available via the device. This is particularly true for the nomadic types of PCs (laptops, netbooks, Mobile Internet Devices, etc), and the high end mobile devices (smart phones). The convergence also involves the access technologies themselves. For instance, a femtocell is a cellular access point, which can be deployed in the homes. It offers short range cellular radio coverage, but uses the fixed broadband connection of the home as a backhaul to the core cellular network.

Three different converged IP core networks 20 are represented in FIG. 1: the public Internet at large 22, a networking service provider network 24, and an IMS (IP Multimedia Sub-system) network 26. The notion of converged IP core networks 20 in FIG. 1 is different from its traditional scope, which usually ties a specific core network to a specific access technology (for instance in the case of a mobile network). The term converged IP core used in the present method and system refers to the utilization of the IP networking technology to interface any type of Internet service 30 with any type of access network 10, using various types of IP core networks (22, 24, 26) for this purpose.

The networking service provider network 24 represented in FIG. 1 includes the traditional IP core network of a network Operator, either a mobile Operator or a fixed broadband ISP (Internet Service Provider). It is directly connected to the access network 10: respectively mobile 14 or fixed broadband 12 access network. A subset of the Internet services 30 may be directly hosted and managed by the network Operator, in this networking service provider network 24.

The networking service provider network 24 is also connected to the public Internet 22, from which Internet services 30 from a wide range of third party application service providers can be accessed. Also, the networking service provider network 24 may be connected to an IMS network 26 of the network Operator, from which a mix of proprietary (network Operator), and third party, Internet services 30 may be accessed. IMS is a reference network architecture for deploying converged Internet services, which can be accessed seamlessly via different access technologies (mobile 14 and fixed broadband 12 in FIG. 1).

The networking service provider network 24 represented in FIG. 1 also includes privately owned IP based infrastructure networks. For instance, such a network is used to interconnect the mobile networks of various mobile Operators (it is usually referred to as the IP exchange—IPX). It is an alternative to using the public Internet 22 for interconnection purposes, when strict constraints related to security, quality of service, and bandwidth (to name the most common ones) must be enforced. As such, these types of infrastructure networks are also an important part of the converged IP core networks 20.

Several types of Internet services 30 are represented in FIG. 1: traditional web browsing 31, IPTV and VOD 32, video and audio streaming 33, on-line gaming 34, messaging 35, social networking 36 and e-commerce 37. They are representative of the wide range of Internet services available to the end users and cover various aspects of their activities (communications, leisure, work, commerce . . . ).

Initially, web browsing 31 was available on a PC 4 via a fixed broadband access network 12. Today, it is also available on a mobile phone 6 via a mobile access network 14. Also, web services 31 were initially accessible via the public Internet 22. Today, proprietary web portals have been developed and hosted by mobile Operators or ISPs. These web portals are accessible directly via the networking service provider network 24. Finally, value added interactive web services are now available on a TV set 2, via a fixed broadband access network, as a complement to standard television services.

IPTV and VOD 32 are available on a TV set 2 via a fixed broadband access network 12. Mobile Operators have also deployed technologies to make IPTV services available on a mobile phone 6 via the mobile access network 14. The IMS network 26 is generally considered as an effective technology to facilitate the distribution of converged IPTV and VOD services, which can be accessed seamlessly from a TV set 2 or a mobile phone 6, respectively via a fixed broadband access network 12, or a mobile access network 14. A laptop 4 (or any similar nomadic device, including a netbook, a Mobile Internet Device like a tablet, etc) benefits from this convergent approach, allowing the consumption of IPTV or VOD services anywhere, using the most appropriate access network technology 10, based on the current device location.

Video and audio streaming 33 are similar to IPTV and VOD 32 in terms of networking and applicative technologies involved. However, video and audio streaming offerings are available for free or as a paid service, from a multitude of third party service providers. On the other hand, IPTV and VOD offerings are traditionally supported by ISPs and mobile Operators themselves, as part of their value added services (however, some independent service providers are trying to bypass the traditional network Operators, offering IPTV or VOD services directly on the network Operators infrastructure). As regards video and audio streaming, the most common way of consuming these services is on a PC 4 via a fixed broadband access network 12. Alternatively, these services are also available on a (high end) mobile phone 6, via the mobile access network 14.

On-line gaming 34 is available on a TV set 2 (with a dedicated video game console) or on a PC 4 via a fixed broadband access network 12; and on a mobile phone 6 via a mobile access network 14. Today, the games available on a mobile phone are still different from those available on a PC or a TV set (in terms of complexity and multimedia experience). However, in the near future, one can expect a convergence, specifically for on-line gaming. In this perspective, the IMS infrastructure 26 is a suitable technology to offer a uniform end user experience, independently of the access network technology and end user platform.

Initially, messaging 35 was available on a PC 4 via a fixed broadband access network 12. Its most common form is the traditional e-mailing technology. It has been extended to offer web based instant messaging capabilities via web portals. Today, it is also available on a mobile phone 6 via a mobile access network 14. The possibility to offer messaging services on a TV set 2, as part of advanced interactive television services, is also available.

Social networking 36 is a category of interactive Internet services based on the paradigm of the web 2.0. However, it can be seen as a combination and extension of traditional web 31 and messaging 35 services. As such, the characteristics of web and messaging services which have been described previously can be applied to social networking.

E-commerce 37 can be considered as a sub-category of the generic web services 31. As such, the characteristics of web services which have been described previously can be applied to e-commerce.

VoIP (Voice over IP) is an additional type of Internet service (not represented in FIG. 1), originally available on a computer (e.g. a laptop 4), via a fixed broadband access network 12. The usage of VoIP has been extended to mobile access networks 14, and to mobile devices 6.

In the previous examples, several use cases have been developed for each type of Internet services 30 described in FIG. 1. Although they cover a large range of possibilities, the scope of the present method and system should not be limited to these examples, but could be easily extended to additional types of Internet services, and also to additional ways of accessing the Internet services which have been mentioned.

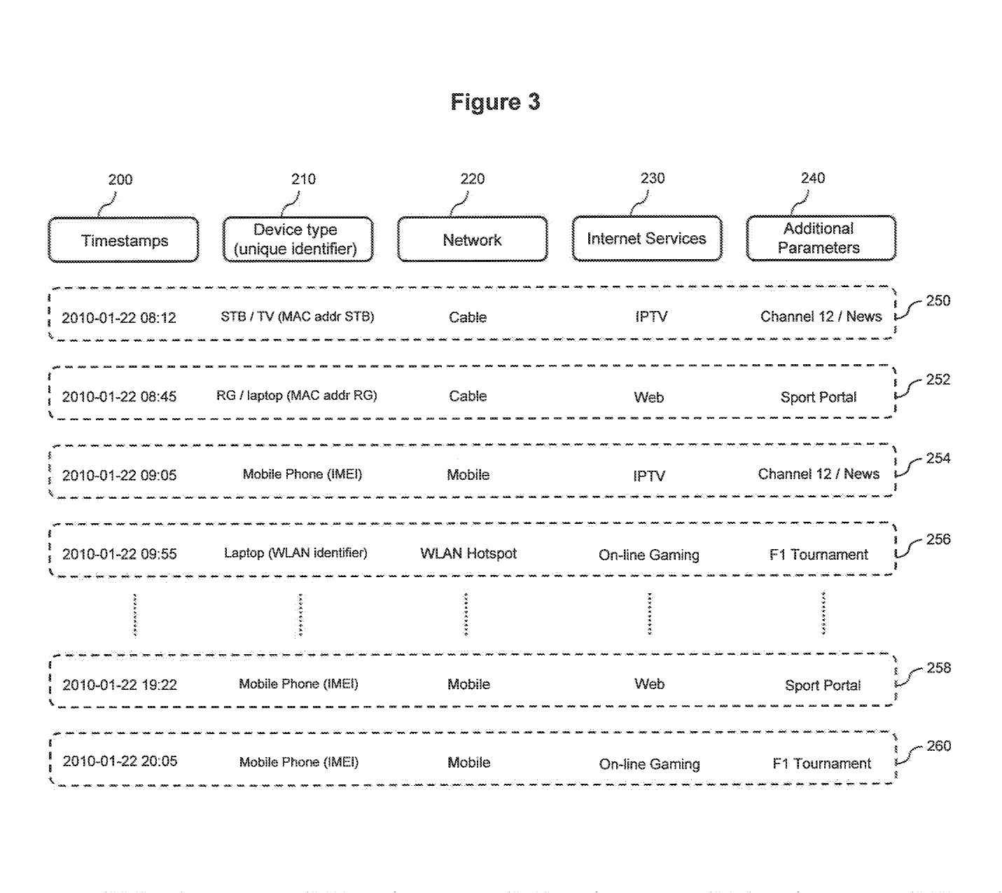

Today, a single user usually has a subscription to a fixed broadband service for its household, and a subscription to a mobile service. More and more often, a single network Operator provides both the fixed broadband and mobile subscription, and operates these two access networks as part of a fixed/mobile convergence strategy. Thus, a single user may access a variety of Internet services 30 via different access networks 10, using several devices (e.g. 2, 4, 6). From a marketing perspective, it becomes critical for a converged network Operator to follow, understand, and predict the behaviors of its subscribers, taking into account the variety of devices, access networks, and Internet services, available. The notion of subscriber's journey will be introduced in FIG. 3. It provides a tool for the network Operator to achieve this marketing objective.

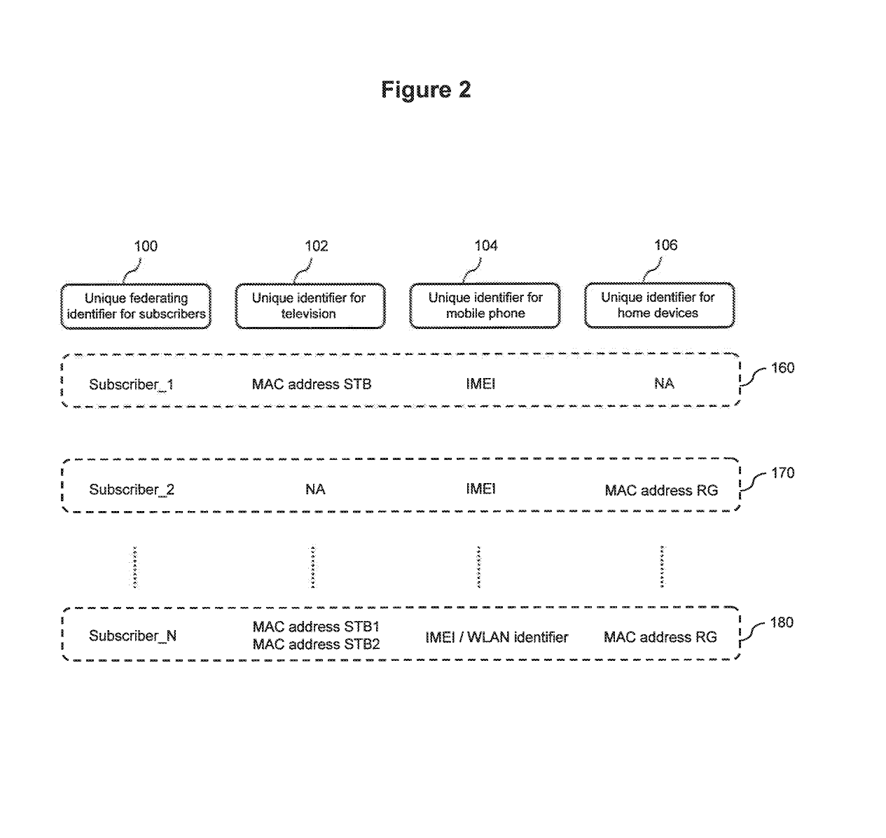

Referring now to FIG. 2, storage of a series of unique identifiers corresponding to specific devices used by a subscriber to access Internet services will be described.

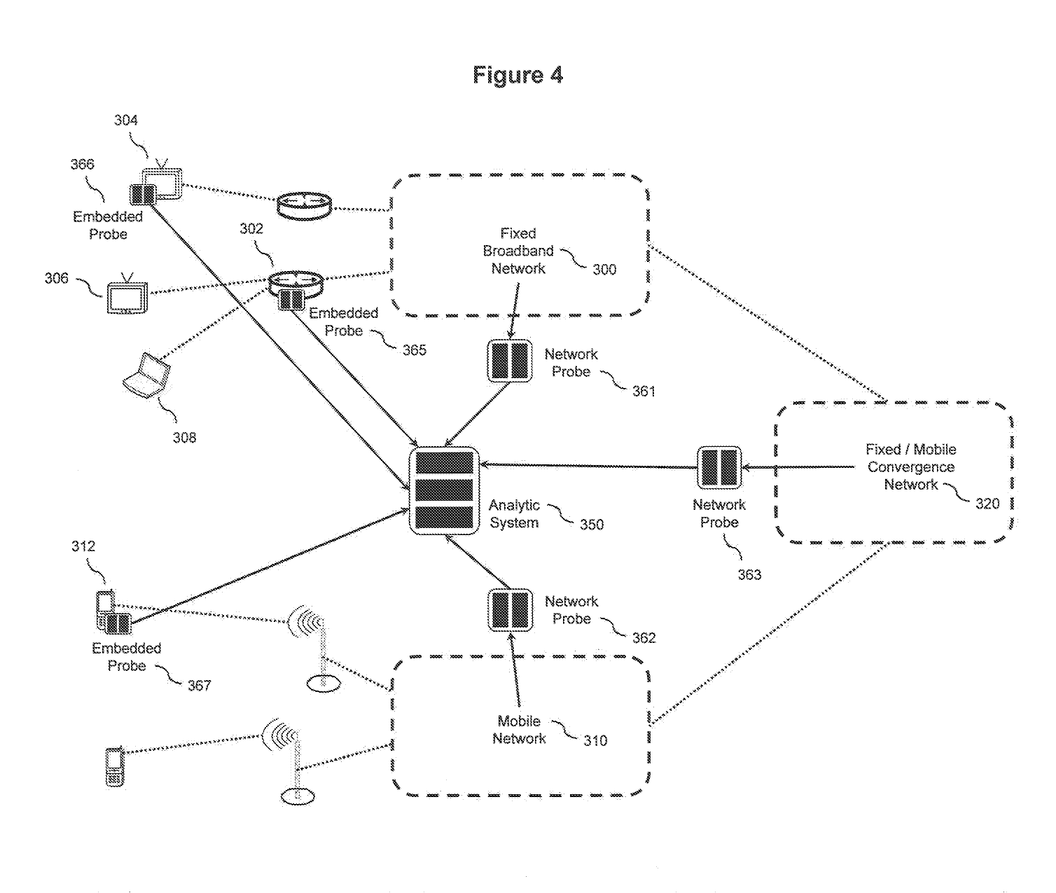

The present method and system relies on the ability to identify a specific subscriber consuming Internet services, whatever the type of device he is using for this purpose. Thus, the converged network Operator maintains in a database a list of the subscribers for which the subscriber's journey is memorized and analyzed. For each subscriber in the database, a series of unique identifiers is stored, corresponding to each specific device that the subscriber uses to consume Internet services. As will be illustrated in FIG. 4, when information is collected in relation to the consumption of Internet services by subscribers, the unique identifier of the device on which the Internet services consumption takes place is collected too. Thus, by interrogating the database with the collected unique identifier of the device, the information related to Internet services consumption is associated to the proper subscriber.

A unique federating identifier is used to federate the multiple unique identifiers associated to the devices owned by each subscriber. This unique federating identifier can be seen as the primary key to the subscribers, in a database terminology. The exact nature of this federating identifier is specific to the converged network Operator. It may be an identifier randomly generated by a computer for each subscriber, according to a pre-defined hexadecimal format. Alternatively, it may be part of the demographic information related to the subscribers, for example their first and family names. For network Operators which have deployed an IMS infrastructure, a Network Access Identifier (NAI) is used as a private identity for uniquely identifying subscribers consuming IMS based Internet services. It usually has the following format: username@operator.com. It is used to correlate several public identities (which can be associated to the same subscriber using various IMS services) to a unique referencing identity (the NAI of the subscriber). In the case where the converged infrastructure of the converged network Operator considered in the present method and system relies partly or entirely on the IMS technology, the use of a NAI as the federating identifier of the subscribers may be a logical choice.

Regarding the unique identifier of each device used by the subscriber to access Internet services, it is dependent on each specific type of device, and on the type of access technology supported by the device. A device may support several access technologies (for example cellular and WLAN for a mobile phone), requiring a unique identifier per access technology supported. Two main constraints apply to this identifier: it must be unique to unambiguously identify the owner of the device. And it must be collectable by one of the monitoring probes described in FIG. 4. As already mentioned, some devices have the capability to provide access to several access technologies (for example to a mobile network and to a fixed broadband network), via different networking interfaces. In this case, it may be necessary to use a specific identifier per access technology, to identify the device (and by extension the subscriber who owns the device, via the associated federating identifier). Additionally, in some cases, the monitoring probes described in FIG. 4 may not be capable of collecting a unique identifier of the device itself, but a unique identifier of a collocated networking equipment used by the device in question to access Internet services.

FIG. 2 represents the information stored in a database to map the unique identifier(s) of each device owned by a single subscriber, to this specific subscriber. We consider (for illustration purposes) a converged network Operator with a mobile network, an IPTV network based on a fixed broadband technology, and a fixed broadband Internet network for fixed Internet access. The IPTV network and the fixed broadband Internet network may or may not be based on the same fixed broadband technology. However, we differentiate the two networks, since the corresponding Internet services (IPTV and fixed broadband Internet) can be subscribed individually by the subscribers (a subscriber may subscribe to IPTV only, to fixed broadband Internet only, or to both).

The first column 100 represents the unique federating identifier for the subscribers of the converged network Operator. One among the possible federating identifiers previously described (randomly generated identifier, subscriber's name, NAI, or any other relevant identifier) is used for this purpose.

The rows 160, 170, and 180, represent three different subscribers with different configurations in terms of devices owned. These three examples of subscribers illustrate the type of unique identifiers used for each type of device. Subscriber_1, subscriber_2, and subscriber_N, (in column 100) represent the unique federating identifiers of these three subscribers.

The second column 102 represents the unique identifier used for the TV set of the subscriber, in the context of the consumption of IPTV services in the household. This identifier is not linked to the TV set itself, but is the Media Access Control (MAC) address of the STB dedicated to this TV set. As already explained, a TV set is directly connected to a STB to access IPTV services. Thus, the STB MAC address is a proper identifier to uniquely identify the device used by the subscriber to access IPTV services. Nowadays, advanced TV sets may include the STB functionality, in which case the TV set itself will have a MAC address, which is used as the unique identifier. Some households may have several STBs (connected to several corresponding TV sets), in which case the MAC address of each STB is mapped to the same subscriber of the IPTV service. Following is an example illustrated in FIG. 2. Subscriber_1 on row 160 owns a STB, which MAC address is memorized. Subscriber_2 on row 170 does not own any STB (he has not subscribed to the IPTV service of the converged network Operator). A Non Applicable (NA) indication is memorized. Subscriber_N on row 180 owns two STBs. Their respective MAC addresses are both memorized.

The third column 104 represents the unique identifier used for the mobile phone of the subscriber, in the context of the consumption of Internet services via a mobile network. In any type of mobile network, the mobile devices are allocated a unique identifier by the manufacturers. For example, in the case of a Universal Mobile Telecommunication System (UMTS) network or a Long Term Evolution (LTE) network, the International Mobile Equipment Identity (IMEI) uniquely identifies each mobile phone. In the case of a Code Division Multiple Access (CDMA) network, an equivalent of the IMEI is used. And in the case of a Microwave Access (WIMAX) network, the unique identifier is a MAC address allocated to the mobile terminal. Following is an example, illustrated in FIG. 2, where the mobile network is an UMTS network. Subscriber_1 on row 160 owns a mobile phone, which IMEI is memorized. Subscriber_2 on row 170 owns a mobile phone, which IMEI is memorized. Subscriber_N on row 180 owns a mobile phone, which IMEI is memorized. This last mobile phone also has a WLAN interface, allowing the subscriber to use a fixed broadband Internet connection (at home or in a WLAN hotspot operated by the converged network Operator). When using the mobile phone at home, to access Internet services via its WLAN interface, the MAC address of a Residential Gateway (RG) is used to identify the subscriber. It is similar to the use case of computers 106, and will be explained in the following. When using the mobile phone in a WLAN hotspot, to access Internet services via its WLAN interface, the identifier of the mobile phone may be the MAC address of its WLAN interface, or an identifier used to authenticate the subscriber when accessing the WLAN hotspot. This specific identifier used in the case of an access to WLAN hotspots is memorized, and represented as “WLAN identifier” on row 180 for the mobile phone 104.

In the case of a mobile network, if for any reasons the unique identifier of the mobile device cannot be used (for example, it cannot be collected by the monitoring probes represented in FIG. 4), a unique identifier related to the subscriber who owns the mobile device may be used instead. For example, in the case of a UMTS or LTE mobile network, the International Mobile Subscriber Identity (IMSI) can be used: it uniquely identifies the subscriber, and it can be collected by a monitoring probe represented in FIG. 4. Alternatively, the Mobile Subscriber ISDN (MSISDN) can be used: it is the phone number of the subscriber, and it can also be collected by a monitoring probe represented in FIG. 4. Similar identifiers of the subscribers who own the mobile devices are available in other mobile technologies, like CDMA or WIMAX.

Additional equipments like laptops, netbooks, Mobile Internet Devices, may have a mobile networking interface to access mobile networks. This mobile networking interface has a unique identifier like a traditional mobile phone, for example an IMEI. Thus, such equipments with an interface to access mobile networks, and a subscription to mobile services with the converged network Operator, appear in the column 104 dedicated to mobile phones. Their IMEI is memorized, in relation to the subscriber who owns the mobile service subscription associated to the laptop, netbook, or Internet Mobile Device. These equipments may also contribute to column 106, when used in the context of a fixed broadband Internet connection (via a different network interface like a WLAN interface).

The fourth column 106 represents the unique identifier for home devices owned by the subscriber, and used in the context of the consumption of Internet services via a fixed broadband Internet connection at home. The term “home devices” is used, to represent any type of device allowing access to Internet services (other than IPTV) over a fixed broadband Internet connection. Currently, it mainly consists in computers. Since it is not practical (and usually not even feasible) to uniquely identify each individual home device, the MAC address of a Residential Gateway (RG) is used as a unique identifier representing all the home devices. The RG is the equipment directly connected to the fixed broadband network, and providing Internet connectivity to the household (e.g. via intra-household WLAN and Ethernet connections). There is one RG per subscriber, and the MAC address of its networking interface connected to the fixed broadband network uniquely identifies each subscriber. Following is an example illustrated in FIG. 2. Subscriber_1 on row 160 does not have a fixed broadband Internet connection for Internet services (at least not with the converged network Operator we consider). A Non Applicable (NA) indication is memorized. Subscriber_2 on row 170 has a fixed broadband Internet connection and the MAC address of its RG is memorized. Subscriber_N on row 180 has a fixed broadband Internet connection and the MAC address of its RG is memorized.

For simplification purpose, the case of the WLAN hotspots is not represented in FIG. 2. An additional column could be added, to take into account the WLAN hotspots operated by the converged network Operator. As already mentioned, the unique identifier memorized for users accessing the WLAN hotspots may vary. It may be a unique authentication identifier used by a subscriber to get access to the WLAN hotspot. Or it may be an identifier of the device itself, for instance its MAC address. Laptops or mobile phones with a WLAN interface represent devices allowing access to WLAN hotspots. For example, a mobile phone is identified by its IMEI when accessing a mobile network, and by the MAC address of its WLAN interface (or an authentication identifier) when accessing a WLAN hotspot. A laptop is identified by the MAC address of the RG when accessing fixed broadband Internet services at home, and by its own MAC address (or an authentication identifier) when accessing a WLAN hotspot.

In the case of the television 102, or the home devices 106, several end users in the same household may use these devices, and it is not possible to identify them individually. They are all related to the same unique subscriber, who subscribed to the IPTV service, and/or to the fixed broadband Internet service. The journey described in FIG. 3 is related to a unique subscriber of various Internet connectivity services: IPTV, mobile, and fixed broadband Internet services. In the case of a household with several persons, the subscriber's journey, for the IPTV service and/or for the fixed broadband Internet service, is representative of the various members of the household. In the case of a mobile service, the subscriber's journey is representative of a single person. Possibly, the common household subscription, to the IPTV service and/or to the fixed broadband Internet service, may be aggregated with the individual subscriptions (of the household members) to mobile services. The outcome is the generation of a household's journey (the constraint is that all the mobile services are provided by the same converged network Operator). The case of an individual subscriber is easier to handle: there is a single subscription to various Internet access services, which are merged to generate the journey.

In the case of a subscriber's journey representative of several members of a household, various technologies may be used to further identify each specific member of the household. In an example of implementation, this may be done by monitoring identities used on the Internet, credit card accounts, online banking, purchases, social networking accounts, etc. Alternatively, the type of content accessed via the Internet services, and the on-line behavior of the various members of the household, may be used to identify them.

Referring now to FIG. 3, a subscriber's journey will be described.

All the activities of a subscriber related to Internet services consumption are recorded, taking into account any type of device and any type of access network used by the subscriber. The aggregation of this recorded information constitutes the subscriber's journey. The means for collecting and recording this information will be detailed in FIG. 4. One assumption is that all the subscribers, for whom the journeys are generated, belong to a single converged network Operator. In the example illustrated in FIG. 3, the network Operator in question operates a mobile network, a cable fixed broadband network, and a network of WLAN hotspots. The fixed broadband network based on the cable access technology offers IPTV services, and fixed broadband Internet services, to households (these two services are differentiated, as was the case in the description of FIG. 2—fixed broadband Internet services refers to the provisioning of an access to any type of Internet services different from the IPTV services, over the fixed broadband network). In the context of the present method and system, the network Operator shall operate at least two different access networks, usually a mobile network (e.g. cellular or WIMAX) and a fixed broadband network (e.g. cable, DSL, optical fiber). Alternatively, the network Operator may have a partnership with another (several others) network Operator, and be granted access to the data collected on the access networks of its partner, to generate the subscribers' journeys through all the access networks of interest.

The subscriber's journey records described in FIG. 3 are generated with the data collected and recorded by various probes, monitoring the subscriber's activity (the IP traffic related to Internet services consumption) on several IP based data networks, as will be illustrated in FIG. 4. The information for each record includes: timestamps 200, the type of device (and its unique identifier) 210, the type of access network 220, the type of Internet service 230, and additional parameters relevant to a specific type of Internet service 240. Any additional information of interest may be added, though it is not represented in FIG. 3.

For each record, two timestamps 200 are used to indicate the beginning of the usage of a specific Internet service, and the end of its usage. A single timestamp per record is represented in FIG. 3 for simplification purposes. A good granularity of the timestamps (typically the second) is preferred.

For each record, the type of device 210 used to consume a specific Internet service is indicated. In the example illustrated in FIG. 3, three types of devices owned by one subscriber are considered: a TV set, a laptop, and a mobile phone. Additionally, the unique identifier of the device, as already described in relation to FIG. 2, is also indicated for illustration purposes.

For each record, the type of access network 220 used to consume a specific Internet service is indicated. In the example illustrated in FIG. 3, three types of access networks are considered: cable (fixed broadband), mobile, and WLAN hotspot. As already mentioned, the assumption is that these three access networks are operated by a single network Operator, interested in the generation of the subscriber's journey. Optionally, one of the access networks may be operated by a partner of the considered network Operator.

For each record, the type of Internet service 230 consumed by the subscriber is indicated. A record is dedicated to a single Internet service, consumed on a single device via a single access network. If necessary, a record may be divided into sub-records, for instance to take into account a variation of the additional parameters 240 for the same Internet service 230. The type of Internet service is expressed in a high level description meaningful to the marketing team of a network Operator. In our example in FIG. 3, the following Internet services are represented: IPTV, web browsing, on-line gaming. Two types of IPTV services are considered in the context of FIG. 3. An IPTV service for TV sets in the household, distributed via the cable fixed broadband connection. And an IPTV service for mobile phones, distributed via the mobile infrastructure. Any type of Internet service 30, as described in FIG. 1, may be represented here; as well as any additional relevant Internet service not mentioned in the present method and system.

Additionally, details about the underlying Internet protocols and applications related to a specific instance of an Internet service may be included in the subscriber's journey. For instance, messaging represents one of the relevant Internet services for the subscriber's journey. However, there are multiple applications which provide a messaging service. Thus, it may be of interest for the network Operator to know more precisely which specific application and/or Internet protocols are used, when an instance of the messaging service occurs.

For each record, additional parameters 240 relevant for a specific type of Internet service 230 are indicated. The type and the number of additional parameters is fully dependant on the Internet service considered. Examples of such additional parameters appearing in FIG. 3 are given in the following.

There may be some overlapping in the timestamps 200 related to different records. This is due to the fact that several Internet services 230 may be used in parallel. This is particularly true for a computer, and now for high end mobile phones, which can run several applications in parallel.

Examples of records constituting a subscriber's journey are given in FIG. 3: 250, 252, 254, 256, 258, and 260. The following devices are owned by the subscriber: a mobile phone, a laptop and a TV set. The fact that the TV set (and potentially the laptop) may be shared among several users will be addressed later.

Record 250 logs the consumption of IPTV on the TV set via the cable network, with the following additional parameters: news have been viewed on channel 12. Both the channel (12) and the type of program viewed (news) is logged. As already explained, the STB associated to the TV set is usually used in place of the TV set itself, for generating the journey. The monitoring probes described in FIG. 4 collect the activity of the STB, and the unique identifier 210 of the STB (MAC address of the STB) is recorded, for further mapping to the related subscriber as described in FIG. 2.

Record 252 logs a web browsing activity on the laptop via the cable network, with the following additional parameter: a sport portal has been accessed. In fact, two additional parameters are recorded: the URL (Uniform Resource Locator) of the portal, as well as a classification of the portal content: sport. The classification of the web pages viewed by a subscriber is a complex task, which can be based on the analysis of the URL, or on the analysis of the web pages content. It is out of the scope of the present method and system, but is considered to be achievable with the appropriate technology. Record 252 illustrates the potential need for the use of sub-records. If different types of web portals are accessed during the same browsing session, a sub-record can be created for each different portal, logging the appropriate timestamps 200, and additional parameters 240 (URL and classification of portal content). As already explained, the RG associated to the laptop is usually used in place of the laptop itself for generating the journey in the context of a fixed broadband Internet connection. The monitoring probes described in FIG. 4 collect the activity of the RG, and the unique identifier 210 of the RG (MAC address of the RG) is recorded, for further mapping to the related subscriber as described in FIG. 2. It is usually not possible to individually distinguish the various devices (including the laptop) which are provided Internet connectivity via the RG.

Record 254 logs the consumption of IPTV on the mobile phone via the mobile network, with the following additional parameters: news have been viewed on channel 12. Both the channel (12) and the type of program viewed (news) is logged. As already mentioned, the IPTV service 254 consumed on the mobile phone is considered as different from the IPTV service 250 consumed on the TV set. The unique identifier 210 of the mobile phone (IMEI) is recorded, for further mapping to the related subscriber as described in FIG. 2.

Record 256 logs an on-line gaming activity on the laptop via a WLAN hotspot, with the following additional parameter: the game in use is Formula 1 tournament. As already explained in relation to FIG. 2, this record of the journey is dependent on the availability of a unique identifier of the laptop when accessing the WLAN hotspots of the converged network Operator; this unique identifier 210 of the laptop on the WLAN hotspot (WLAN identifier) is recorded, for further mapping to the related subscriber as described in FIG. 2.

Record 258 logs a web browsing activity on the mobile phone via the mobile network, with the following additional parameter: a sport portal has been accessed. In fact, two additional parameters are recorded: the URL (Uniform Resource Locator) of the portal, as well as a classification of the portal content: sport. The unique identifier 210 of the mobile phone (IMEI) is recorded, for further mapping to the related subscriber as described in FIG. 2.

Record 260 logs an on-line gaming activity on the mobile phone via the mobile network, with the following additional parameter: the game in use is Formula 1 tournament. The unique identifier 210 of the mobile phone (IMEI) is recorded, for further mapping to the related subscriber as described in FIG. 2.

All the subscribers' journeys are further analyzed from a Business Intelligence perspective by an analytic system. The positioning of the analytic system in the global solution will be detailed in FIG. 4. The analytic system consists of two main components. First, a high performance database to store the subscribers' journeys according to an optimized data model, and over a long enough duration (e.g. one or up to several years). Secondly, a business intelligence tool to perform analysis and data mining on the recorded subscribers' journeys, in order to generate statistics, findings, KPI (Key Performance Indicators) for the marketing and product development teams of the converged network Operator.

The main goal is to analyze the impact of providing converged Internet services, in order to understand emerging subscriber's behaviors, and discover new opportunities to develop revenues. For instance, by determining how the availability of specific Internet services on various access technologies and devices influences and modifies the subscriber's usage, the same dynamics can be applied to legacy non converged Internet services and drive the development of new converged Internet services.

One exemplary use case is a modification of usage due to ubiquitous availability. For example, it has a growing impact in the case of on-line gaming. The traditional way to play was at home, on a computer or on a TV set (using a video game console), via a fixed broadband Internet connection. Now, it is possible to enjoy on-line gaming almost everywhere via a smart phone or a nomadic computer, using a mobile or WLAN hotspot connection. By analyzing the subscribers' journeys, focusing on on-line gaming, some generic trends can be discovered: matching a specific category of on-line video games with a particular consumption pattern. The result may be, for example, that it is not worth developing a certain category of on-line video games for mobile usage, since users prefer to play them at home on a fixed computer or TV set. On the contrary, other categories may be well suited to mobile usage (smart phone and nomadic computer), to the point where such video games might be developed exclusively for mobile platforms. The last category would be ubiquitous on-line video games, for which the end user is willing to play at anytime and anywhere. In this case, it is necessary to adapt this type of game to any available device and access technology, and possibly offering a premium service granting this ubiquitous availability (the revenue generated by this premium fee can be shared between the game distributor and the converged network Operator).

Ubiquitous availability also has a growing impact on the consumption of television as an Internet service. IPTV is now available on any type of device, and via any type of access technology (fixed broadband, mobile). The analysis of the subscribers' journeys can help segment the different types of programs among categories. One category includes programs preferably consumed at home (or more generally in a fixed location), like documentaries, sport events, movies. Another category includes programs preferably consumed on the move, like short news reports. Another category includes programs followed on any kind of available medium, leveraging the ubiquitous availability of IPTV. For example, short television series are now adapted to be viewed on traditional TV sets, computers, and smart phones; live or as a VOD service. Thus, the end user has the capability to view this type of series anywhere, anytime. Additionally, the emergence of the following trends may be detected: transition from IPTV programs originally consumed exclusively at home, now being increasingly consumed on mobile devices; emergence of new IPTV programs consumed almost exclusively on mobile devices like smart phones.

Another use case is the identification of new usages involving the consumption of several related Internet services over various devices and access technologies. By an in-depth analysis of the subscribers' journeys, such tendencies can be discovered. The idea is that the consumption of these different Internet services through a converged experience brings more value to the end user, compared to the consumption of each Internet service individually. The network Operator can use this experience to extrapolate which combination of Internet services may be appealing to the subscriber, and to build value added Internet services offerings, including a combination of several Internet services over multiple end user devices and access technologies. For example, viewing (via a TV set at home) of thematic television channels focusing on music and movies, or news, can be related to the access (via a smartphone) to dedicated web portals for buying and downloading related music and movie programs, or short news articles. More generally, an interesting aspect to understand is the correlation between free Internet services and premium Internet services, the first type being identified as an incentive for the consumption of the second type.

Another use case is the segmentation of the subscribers by groups of users with similar behaviors and expectations in terms of Internet services offerings. By analyzing the subscribers' journeys, some groups of users with specific consumption patterns are identified (e.g. same types of Internet services consumed over same type of device and via same access technology). These patterns may then be related to user demographics information, like age, sex, localization, average revenues, and the likes. If an association can be made between consumption patterns and demographics patterns, it can be used as a marketing tool by the network Operator, to propose specific Internet services, rate plans, Internet services bundles (through a matching of the consumption patterns to members of the corresponding demographic groups).

Another use case is the gathering of operational statistics for each Internet service, over each device, and via each access technology. Such statistics include, to name the most common, the volume of data, the duration of use, the time of use, the average number of users, and the localization during the use. This type of information is critical to decide on the most appropriate billing strategy. Innovative Internet services bundles and billing policies can be derived from the aforementioned statistics, to better differentiate the offerings of the converged network Operator from its competitors.

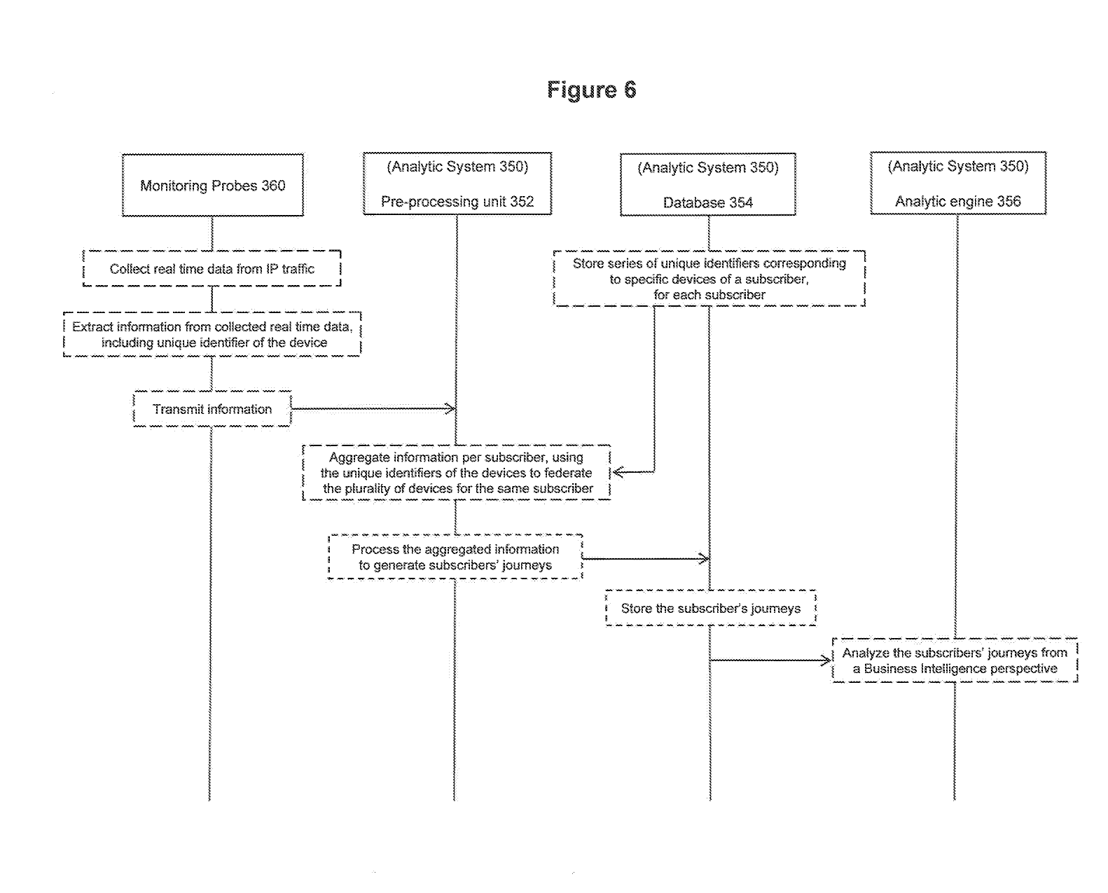

Referring now concurrently to FIGS. 4, 5, and 6, a method and system for subscriber's journey analytics will be described.

The first step consists in collecting raw data related to Internet services consumption. For this purpose, several monitoring probes distributed over a set of locations collect the raw data. Since the Internet services are consumed on a variety of devices, in different locations, and via various access network technologies, it is not possible to have a single monitoring probe located in a single emplacement to collect all the necessary data.

An optimal way to collect the raw data is to deploy network probes in the different types of access network infrastructures. Usually, for each type of access technology, there is one or several point(s) of convergence, where the IP traffic related to Internet services consumption is aggregated. This is the ideal point of deployment for a network probe. For instance, as illustrated in FIG. 4, a network probe 361 collects the IP traffic (related to Internet services consumption) flowing through the fixed broadband network 300 and a network probe 362 collects the IP traffic (related to Internet services consumption) flowing through the mobile network 310.

Though a single network probe per access technology is represented in FIG. 4, the deployment of several of these network probes is usually necessary to cover the breadth of a network Operator infrastructure. For instance, in the case of a mobile network 310 based on the UMTS (Universal Mobile Telecommunication System) technology, the GGSN (Gateway GPRS Support Node) is one point of convergence for the IP traffic related to Internet services consumption. Thus, a network probe 362 is deployed at each GGSN, to collect the IP traffic related to the Internet services consumed by the subscribers. Since the number of GGSNs deployed in an UMTS network is limited to a few instances, this is a very effective way to collect the aforementioned IP traffic.

In the case of a fixed broadband network based on the DSL (Digital Subscriber Line) technology, the network probe 361 may be deployed at different points of the network infrastructure, depending on architectural choices made by the network Operator. For example, the network probe 361 may collect the traffic aggregated by a DSLAM (Digital Subscriber Line Access Multiplexer). Since this equipment is close to the end user, the number of DSLAMs deployed in a typical DSL network may reach thousands of units, involving scalability issues for the deployment of the network probes 361. Alternatively, the network probe 361 may collect the traffic aggregated by a BRAS (Broadband Remote Access System). Since a single BRAS aggregates the IP traffic of many DSLAMs, the number of BRAS in a typical DSL network ranges from one to a few, making this second type of deployment more scalable. Generally speaking, the network probes 361 deployed in the fixed broadband network 300 collect the IP traffic related to the Internet services consumed by the subscribers.

Beyond the aforementioned examples, the deployment of the network probes 361 and 362 can be generalized to any kind of fixed broadband network 361 (e.g. DSL, cable, optical fiber) and mobile network 310 (e.g. cellular or WIMAX).

The network probes 361 and 362 are based, for example, on the DPI (Deep Packet Inspection) technology, which is well known in the art. It relies on the inspection of IP packets along the various network layers of the OSI (Open Systems Interconnections) model. The main layers to consider are the network layer, the transport layer, the session layer, and the applicative layer. Various parameters are extracted along these layers, allowing the correlation of various IP packets inside a single applicative flow, the recognition of the protocols and applications in use for each of these flows, and the extraction of specific data relevant to a particular type of protocol or application. Ultimately, a given type of Internet service is characterized by the aforementioned collection of information.

For most Internet services, which can be consumed on several different access network technologies, like web browsing, a dedicated network probe 361 or 362 must be used for each access technology, in order to collect the related IP packets and extract the information necessary to generate the subscribers' journeys. However, with the convergence of Internet services delivered over various access technologies, it becomes possible to deploy a network probe 363 in a fixed/mobile convergence network 320. Such a fixed/mobile convergence network 320 can be defined as a network where the access to converged Internet services is centralized. The fixed/mobile convergence network 320 provides a normalized interface to a selection of converged Internet services. It performs (if necessary) the adaptation (e.g. video adaptation) of the Internet services delivered, to the specificities of each access network technologies 300 and 310.

An example of such a fixed/mobile convergence network is the IMS. The SIP (Session Initiation Protocol) protocol is used to control the access to IMS based Internet services, and to perform the adaptation to a specific access network technology, and possibly to the end user specific device capabilities. In this context, different protocol characteristics, and possibly even different protocols, are selected to deliver the data related to the IMS based Internet services, based on the access technology and end user device. In particular, the IMS has been specified to play this role relatively to the fixed broadband networks 300, and the mobile networks 310. Internet services supported by the IMS infrastructure include VoIP (Voice over IP), various types of multimedia delivery services (audio and video), IPTV, and in a near future on-line gaming.

A critical advantage brought by the deployment of a single network probe 363 in the fixed/mobile convergence network 320 is that it can capture the data usually collected by multiple network probes 361 and 362 deployed in the specific access networks 300 and 310. This only applies to the Internet services supported by the converged network, like those mentioned before for the IMS. However, it is likely that only the signaling traffic related to the Internet services will go through the fixed/mobile convergence network 320. The related data traffic will be directly fed to the appropriate access network 300 or 310, via a media delivery and adaptation infrastructure. However, in many cases, capturing the signaling traffic (e.g. SIP based control traffic) is sufficient to characterize the Internet service in use, and there is no need to capture the related data traffic. For instance, in the case of IPTV, the control traffic is sufficient to follow which channel a user is viewing at which time, and the data traffic does not need to be captured.

Alternatively, monitoring probes may be deployed closer to the end user. In the case of the mobile network 310, an embedded probe 367 can be integrated to the mobile phone 312. This embedded probe has capabilities similar to the network probe 362 in terms of DPI, although the available processing power on the mobile phone may be a limiting factor in terms of protocol analysis. Given the growing flexibility and modularity of mobile phone software, adding an embedded DPI probe is feasible. Alternatively, the embedded probe 367 may operate at the application layer to monitor the Internet services in use and the relevant parameters. In this latter case, a close integration with the mobile phone applicative software and operating system is necessary, and is more complex to implement. However, using a network probe 362 is preferable to using an embedded probe 367, in terms of scalability, considering the wide range of mobile phone models for which the embedded probe must be adapted (to taking into account the specificities of the software and hardware of each model of mobile phone).

In the case of the fixed broadband network 300, an embedded probe 366 can be integrated to the STB (not represented in FIG. 4) associated to the TV set 304. This embedded probe only monitors specific Internet services related to IPTV: linear television, VOD, interactive Internet services linked to the IPTV service. Since it is integrated to the STB, the embedded probe 366 can not only perform standard DPI operations, but also monitor specific events like time shifted television viewing, DVD (Digital Video Disk) viewing, interaction with a remote control, and the likes.

For the fixed broadband network 300, an embedded probe 365 can also be integrated to the RG 302. The RG 302 is the equipment providing IP connectivity, for the members of the household, to the fixed broadband access network 300. The embedded probe 365 collects the data related to the consumption of all kinds of Internet services for the household. The data include the Internet services consumed on a computer 308, and may also include the IPTV services consumed on a TV set 306 (the monitoring of the IPTV services is then performed at the RG level, instead of the STB level as previously described).

Each monitoring probe has the capability to capture the unique identifier of the device used by the subscriber to consume Internet services, as explained in relation to FIG. 2. In the case of the network probe 362, we consider that the mobile network 310 is an UMTS network for illustration purposes. The unique identifier captured to identify the mobile phone of the subscriber is the IMEI (alternatively the IMSI or the MSISDN). This identifier can be captured on the Gn interface of the GGSN, by analyzing the control plane of the GPRS Tunneling Protocol (GTP) protocol. Alternatively, this identifier can be captured on the Gi interface of the GGSN, by analyzing the Remote Authentication Dial In User Service (RADIUS) messages used for authentication, authorization and accounting purposes. If an embedded probe 367 is used, the IMEI (alternatively the IMSI or the MSISDN) is directly extracted from a permanent memory on the mobile phone 312, where it is stored.

In the case of the network probe 361, the MAC address of the RG and the MAC address of the STB, are the unique identifiers of the devices used to identify the subscribers. These MAC addresses are extracted from the IP traffic generated by the RG and the STB, in the context of the IPTV service and the fixed broadband Internet service. Depending on the topology of the fixed broadband network 300, and depending on some networking options, a network probe 361 may not have the capability to capture the MAC addresses of the RG and of the STB. In this case, embedded probes in the RG 365 and in the STB 366 are used, in order to allow the collection of the aforementioned unique identifiers. These embedded probes have inherently access to the targeted MAC addresses.

In the case of the network probe 363, the same unique identifiers as those captured by the networks probes 361 and 362 may be captured, if they are present and can be extracted from the converged IP traffic of the fixed/mobile convergence network 320. Alternatively, a unique identifier of the subscriber may be used to identify the subscriber in the context of converged Internet services operated via the fixed/mobile convergence network 320. For example, the NAI previously mentioned in relation to FIG. 2, in the context of IMS based converged Internet services, may be used.

For every type of network probe described previously, the collected information is usually organized in the form of IP data records in a flat file. Each IP data record contains a unique identifier of a device, and information related to the usage of an Internet service by the device corresponding to the unique identifier.

In some cases, the IP packets collected by a probe contain both the unique identifier of the device, and the data used to generate/update the information related to the usage of an Internet service. Thus, an IP data record is directly generated/updated.

In other cases, the unique identifier of a device is extracted from specific IP packets, and the data used to generate/update the information related to the usage of an Internet service are extracted from other IP packets. A correlation must then be performed to generate the IP data records. For example, in the case of an UMTS mobile network, the IMEI and the IP address of a mobile device are extracted from the GTP control plane. And the data used to generate/update the information related to the usage of an Internet service by a mobile device, as well as the IP address of the mobile device, are extracted from the GTP user plane. The IP address is used to correlate the unique identifier of a device (the IMEI), with the data used to generate/update the information related to the usage of an Internet service by a mobile device.

The second step consists in transmitting the information extracted by the various monitoring probes to an analytic system 350, for the generation of the subscribers journeys, their storage, and for further Business Intelligence analysis of the subscribers' journeys.

The same principle applies for each type of monitoring probes: network based (e.g. 361, 362 and 363) or embedded (e.g. 365, 366 and 367). At regular intervals (e.g. every hour or every day), the monitoring probes transmit the collected information to an analytic system 350. This transmitted information contains records of Internet services consumption events, with at least the following information for each individual record: the type of device used, the access technology used, the Internet service consumed with its specific additional parameters, and related timestamps (in relation to FIG. 3). The unique identifier of the device used by the subscriber (in relation to FIG. 2) is associated to each record, for the purpose of identification of the related subscriber by the analytic system 350. This information is extracted by the monitoring probes from the collected raw data. The information is transmitted preferably in an optimized format (e.g. a compressed flat file), to minimize the amount of information to be transferred between the monitoring probes and the analytic system.

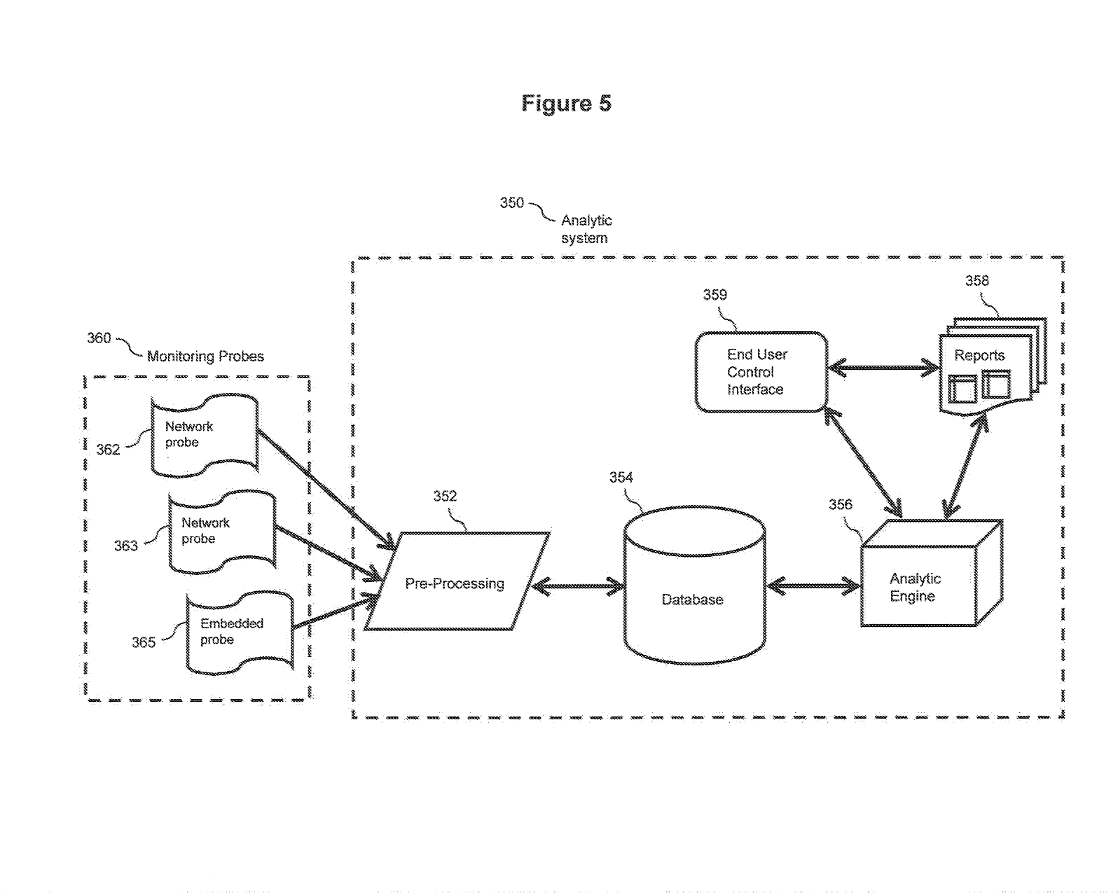

The analytic system 350 comprises a high performance database 354 (as illustrated in FIG. 5), to store the subscribers' journeys (as illustrated in FIG. 3). An optimized data model is used for this purpose, to facilitate the further analysis of the journeys by a dedicated analytic engine 356 (as illustrated in FIG. 5). The database also contains the unique identifiers of the various devices used by each subscriber to access Internet services, for the purpose of uniquely identifying each subscriber, as described in relation to FIG. 2. The information received from the various monitoring probes 360 is pre-processed by a pre-processing unit 352, before its storage in the database 354 (as illustrated in FIG. 5). This step is necessary to adapt the received information to the data model. Also, since the information originates from various access technologies and devices, some form of standardization is necessary, to represent a subscriber's journey in a unified way, as described in FIG. 3.

The dedicated analytic engine 356 of FIG. 5 performs the analysis of the information stored in the database from a Business Intelligence perspective. Such analytic engines are well known in the art of Business Intelligence and data mining. They have the capability to process large amounts of information, to discover trends and behaviors. In the context of the present method and system, these trends and behaviors are related to the consumption of converged Internet services, represented by the subscribers' journeys stored in the database 354 of FIG. 5. Additionally, clusters of subscribers with specific consumption habits and characteristics are identified. The resulting findings are presented to the staff of the network Operator in the form of reports, generated by the report presentation unit 358 of FIG. 5. The reports are mainly visual, relying on various types of charts and diagrams, to present the findings in an intuitive, easy to understand way.

The main targets of these reports, among the staff of the network Operator, are the marketing and product development teams. These teams may use the reports to adapt the offering of converged Internet services. This includes (among others): making new Internet services available via multiple access networks and devices, adapting the pricing, proposing new bundles of Internet services, focusing on end user devices with specific capabilities, identifying clusters of premium subscribers, etc.

Referring now specifically to FIG. 5, an embodiment of the system architecture of the analytic system 350 for performing subscriber's journey analytics will be described.

As represented in FIG. 5, the analytic system 350 introduced in FIG. 4 is composed of the following subentities: a pre-processing unit 352, a database 354, an analytic engine 356, a reports presentation unit 358, and an end-user control interface 359.

The analytic system 350 receives information from multiple monitoring probes 360. The multiple instances of the monitoring probes are deployed at various locations in the networks operated by the converged network Operator (for illustration purposes, three monitoring probes 362, 363, and 365, introduced in FIG. 4, have been represented in FIG. 5). Each instance of the monitoring probes reports information, extracted from the data collected in real time, to the analytic system 350. In case the volume of information to handle is too large, the analytic system 350 may also be split between several instances, to scale.

The implementation of the monitoring probes is well known in the art. Dedicated software, and dedicated hardware in the case of the network probes, is used. Specific technologies, like for example DPI, are implemented in the software and/or in the hardware.

The pre-processing unit 352 consists in a dedicated software executed on a computer, to process the information received from the monitoring probes 360 and to update the database 354. As explained in relation to FIG. 2, for each set of information transmitted by one of the monitoring probes 360 in relation to the consumption of Internet services by a subscriber, the pre-processing unit 352 uses the unique identifier of the device of the subscriber, captured by the monitoring probe (as explained in relation to FIG. 4), to query the database 354 and identify the related subscriber. Then, information related to the subscriber's journey (as explained in relation to FIG. 3) are extracted from the set of information, processed by the pre-processing unit 352, and stored in the database 354, to update the information related to the journey of the subscriber in question.

The database 354 is a traditional database; the underlying technology is well known in the art. It is managed by the pre-processing unit 352, and is the source of information for the analytic engine 356. There is a strong requirement on the performances of the database 354, in terms of volume of information to store, and computing power for the treatment of this information; since tens of millions of subscribers may have to be managed for large converged network Operators. As already mentioned, the main information stored in the database 354 is: the unique identifiers of the devices owned by each subscriber (as illustrated in FIG. 2), and the information related to the journeys of each subscriber (as illustrated in FIG. 3).

The analytic engine 356 is an application software executed on a computer, to generate various metrics related to the subscribers' journeys, as previously explained in relation to FIG. 3. The information contained in the database 354 is queried, aggregated, and processed, by the analytic engine 356 to generate the metrics. Subsets of the metrics are extracted by the reports presentation unit 358, and presented to the end users (the converged network Operator staff) in the form of dashboards.

The reports presentation unit 358 consists in a Graphical User Interface on a computer, to present different types of reports to the end users. These reports are presented in the form of dashboards, combining pre-defined information computed by the analytic engine 356. A pre-defined list of reports is included by default in the analytic engine 356. Some new reports can also be defined, using the end user control interface 359.

The end user control interface 359 also consists in a Graphical User Interface on a computer. It offers two levels of interaction to the end users. Standard end users only interact with the reports presentation unit 358, to request the generation and presentation of a report, selected among the list of pre-defined available reports. When such a report is presented, the standard end user interacts with the report to modify a limited number of parameters and variables, and dynamically update the report (for instance, the characteristics of a subset of the subscribers for whom the journeys are analyzed, the time interval over which the journeys are generated, etc). The report is then automatically updated, with the proper information computed by the analytic engine 530.

Advanced end users have the same level of interaction with the reports presentation unit 358 as the standard end users. In addition, advanced end users are allowed to interact directly with the analytic engine 356. This capability enables an advanced end user to dynamically define a report that is generated by the analytic engine 356, and presented to standard and advanced end users on the reports presentation unit 358. For this purpose, the advanced end user selects which metrics are aggregated to generate the dynamic report, and the analytic engine 356 performs the necessary computation to prepare the data that will be necessary when the report is requested by the reports presentation unit 358. A dynamic report may be later added to the list of pre-defined reports.

Although the present method and system have been described in the foregoing specification by means of several non-restrictive illustrative embodiments, these illustrative embodiments can be modified at will without departing from the scope of the following claims.

1. A method for analyzing journeys of at least one subscriber consuming a plurality of Internet services using at least one device over multiple access technologies, the method comprising:
storing for each subscriber a series of unique identifiers, each unique identifier corresponding to a specific device of the subscriber;
collecting by means of multiple monitoring probes real time data from IP traffic;
extracting information from said real time data, the information comprising one of the unique identifiers ;
aggregating said information per subscriber, using the unique identifiers to federate the plurality of devices for the same subscriber over the multiple access technologies;
generating for each subscriber a journey by processing said aggregated information; wherein a subscriber's journey consists of a list of Internet services consumed by the subscriber, with descriptive parameters.

2. The method of claim 1, wherein said descriptive parameters consist of at least one of the following: timestamps to indicate beginning and end of service consumption, type of device used, access technology used, type of Internet service, additional specific parameters related to each specific Internet service.

3. The method of claim 1, wherein the subscribers' journeys are stored in a database.

4. The method of claim 3, wherein the subscribers journeys stored in the database are further analyzed by the analytic system from a Business Intelligence perspective.

5. The method of claim 4, wherein the analysis from a Business Intelligence perspective includes: determining trends and behaviours among subscribers consuming Internet services over a multitude of devices and access technologies, identifying clusters of subscribers with similar consumption patterns of Internet services over a multitude of devices and access technologies.

6. The method of claim 1, wherein the multiple monitoring probes are deployed at different locations to cover the plurality of devices and access technologies available to the subscribers.

7. The method of claim 6, wherein the multiple monitoring probes deployed at different locations include: network probes deployed in a mobile network, network probes deployed in a fixed broadband network, network probes deployed in a fixed/mobile convergence network, embedded probes deployed in mobile devices, embedded probes deployed in Residential Gateways, embedded probes deployed in Set Top Boxes, embedded probes deployed in televisions.

8. The method of claim 1, wherein the unique identifier corresponding to a specific device of a subscriber includes: an IMEI (International Mobile Equipment Identity) associated to a mobile phone, a MAC (Media Access Control) address associated to a Residential Gateway, a MAC address associated to a Set Top Box, a MAC address associated to a television, a MAC address associated to a computer, a MAC address associated to a mobile device, a WLAN (Wireless Local Area Network) identifier associated to a mobile or nomadic device, an IMSI (International Mobile Subscriber Identity) associated to a subscriber owning a mobile device.

9. The method of claim 1, wherein the types of Internet services include: web browsing, messaging, IPTV (Internet Protocol Television) and VOD (Video On Demand), video and audio streaming, on-line gaming, social networking, e-commerce, VoIP (Voice over IP).

10. The method of claim 1, wherein for each instance of an Internet service in a subscriber journey, the Internet protocols and applications used for said specific instance of said Internet service are included in the subscribers' journeys.

11. A system for analyzing journeys of at least one subscriber consuming a plurality of Internet services using at least one device over multiple access technologies, the system comprising:
a database for storing for each subscriber a series of unique identifiers, each unique identifier corresponding to a specific device of the subscriber;
multiple monitoring probes for collecting real time data from IP traffic, and for extracting information from said real time data, the information comprising one of the unique identifiers;
an analytic system for processing said information transmitted by the multiple monitoring probes, the processing including:
aggregating said information per subscriber, using the unique identifiers to federate the plurality of devices for the same subscriber over the multiple access technologies;
generating for each subscriber a journey by processing said aggregated information; wherein a subscriber's journey consists of a list of Internet services consumed by the subscriber, with descriptive parameters.

12. The system of claim 11, wherein said descriptive parameters consist of at least one of the following: timestamps to indicate beginning and end of service consumption, type of device used, access technology used, type of Internet service, additional specific parameters related to each specific Internet service.

13. The system of claim 11, wherein a database stores the subscribers' journeys.

14. The system of claim 13, wherein the analytic system further analyzes from a Business Intelligence perspective the subscribers' journeys stored in the database.

15. The system of claim 14, wherein the analysis from a Business Intelligence perspective includes: determining trends and behaviours among subscribers consuming Internet services over a multitude of devices and access technologies, identifying clusters of subscribers with similar consumption patterns of Internet services over a multitude of devices and access technologies.

16. The system of claim 11, wherein the multiple monitoring probes are deployed at different locations to cover the plurality of devices and access technologies available to the subscribers.

17. The system of claim 16, wherein the multiple monitoring probes deployed at different locations include: network probes deployed in a mobile network, network probes deployed in a fixed broadband network, network probes deployed in a fixed/mobile convergence network, embedded probes deployed in mobile devices, embedded probes deployed in Residential Gateways, embedded probes deployed in Set Top Boxes, embedded probes deployed in televisions.

18. The system of claim 11, wherein the unique identifier corresponding to a specific device of a subscriber includes: an IMEI associated to a mobile phone, a MAC address associated to a Residential Gateway, a MAC address associated to a Set Top Box, a MAC address associated to a television, a MAC address associated to a computer, a MAC address associated to a mobile device, a WLAN identifier associated to a mobile or nomadic device, an IMSI associated to a subscriber owning a mobile device.

19. The system of claim 11, wherein the types of Internet services include: web browsing, messaging, HDTV and VOD, video and audio streaming, on-line gaming, social networking, e-commerce, VoIP (Voice over IP),

20. The system of claim 11, wherein for each instance of an Internet service in a subscriber journey, the Internet protocols and applications used for said specific instance of said Internet service are included in the subscribers' journeys.
